(19) United States
(12) Patent Application Publication
(10) Pub. No.: US 2015/0064334 A1
(43) Pub. Date: Mar. 5, 2015

(54) High protein egg product and manufacturing apparatus and process

(71) Applicant: Ray M. ALDEN, Raleigh, NC (US)

(72) Inventor: Ray M. ALDEN, Raleigh, NC (US)

(21) Appl. No.: 13/987,751

(22) Filed: Aug. 28, 2013

Related U.S. Application Data
(63) Continuation-in-part of application No. 13/573,242, filed on Sep. 4, 2012.
Application No. 13/573,242 is a continuation-in-part of application No. 13/986,839, filed on Jun. 10, 2013.

(51) Int. Cl. A23L 1/32

(52) U.S. Cl. CPC A23L 1/3212; A23L 1/32; A23V 2002/00
USPC 426/614

(57) ABSTRACT

The invention described herein comprises a crunchy egg product, manufacturing apparatus, and manufacturing processes to produce a desirable consumer product that is nutritious and fulfills a gap in crunchy low carbohydrate snack food product category. The final product comprises a high egg percentage by volume and a low water content by weight, audible fracturing characteristics, and brittleness characteristics. It comprises a low carbohydrate, high protein crunchy snack food for consumption by those on a low carbohydrate diet. Manufacturing steps and apparatuses are described.

### RELATED APPLICATIONS

This patent application is Continuation In Part of U.S. patent application Ser. No. 13/573,242 filed Sep. 4, 2012 and of U.S. patent application Ser. No. 13/986,839 filed Jun. 10, 2013.

### BACKGROUND FIELD OF INVENTION

This invention relates to a food product manufactured for human or animal consumption. More specifically a crunchy, high protein, low carbohydrate product that utilizes egg as a primary ingredient is described. The manufacturing apparatus and manufacturing process are also described.

### BACKGROUND

### Description of Prior Invention

Since before recorded history, humans have consumed eggs as a food. For thousands of years, eggs have been utilized as an important ingredient in thousands of food recipes. As an ingredient, eggs are often mixed into a batter with other ingredients. For example to make hundreds of types of baked goods, a grain such as wheat is used as a primary ingredient, eggs are mixed in to achieve properties such as cohesiveness, texture, and appearance while salt or sugar are added for taste. More recently United States Patent Application 2013/0022731, Olson disclosed a baked or fried food product that mixes a grain starch such as rice flour and egg to produce a snack food product. Also U.S. Pat. No. 7,939,123 Tillis, and U.S. Pat. No. 7,943,191 Tillis describe egg based French Fries with a crispy exterior and with water content between 15% and 25%.

In modern day western civilization, much cost and effort is expended by people trying to lose weight or to remain trim. One very common approach is to eat a diet significantly restricted in carbohydrates such as sugars, grains, starches, and grain flours. People on carbohydrate restricted diets typically substitute in more protein and fat than what is considered a traditional diet but these people can and do loose significant weight. Once a consumer starts a low carbohydrate diet, it quickly becomes apparent to them that few crunchy types of low carbohydrate snack foods are available in a conveniently packaged product. Pork rinds being the only widely available high protein, low carbohydrate, bagged crunchy chip like snack food.

Typical crunchy snack foods such as potato chips, corn chips, pretzels, crackers, and cookies all comprise high carbohydrates or sugars and low protein. Thus people whom are on carbohydrate restricted diets very much miss snacking on many crunchy snack food choices. As described herein, a crunchy snack food made primarily from eggs and with no added grain starch or flour is a good substitute for crunchy snack foods made from carbohydrates such as grain flours, starches, and sugars.

### BRIEF SUMMARY

The present invention comprises the ingredients, apparatus, and manufacturing process required to manufacture a crunchy snack food that is low in carbohydrates and is high in protein. By weight the final crunchy egg product contains a protein to carbohydrate ratio as high as 25.73 parts protein to 1 part carbohydrate. Depending upon ingredient proportions, preparation, and cooking duration, the crunchy egg snack food described herein can take the form of a chip, a pretzel, a cracker, a cookie, a cereal, a puffed extrusion, a pasta, or other forms. The crunchy texture is described in terms of having a low water content, an audible “crack” sound when fractured, and a brittleness as demonstrated in fracture when subjected to even a low angular bend in a Three Point Bend test. During product consumption, the brittleness and sound comprise dimensions known to consumers as “crunchy”. Further the product can be gluten free, lactose free, peanut free, organic, non-gmo, and Kosher.

### Objects and Advantages

Accordingly, several objects and advantages of the present invention are apparent. The present invention utilizes eggs as a primary ingredient. The final product may comprise egg solids between 15% and 95% by volume. Eggs are a well known and accepted form of protein easily metabolized in the human body. Solids in the final product may comprise a protein to carbohydrate ratio as high as 25.73 parts protein to 1 part carbohydrate or as low as 1.49 parts protein to 1 part carbohydrate. Agricultural infrastructure makes eggs readily available in large quantities suitable as a high volume food source. Egg solids prepared and cooked as described herein form a low moisture crunchy product suitable for packaging and distribution as a long shelf life snack product. A large segment of the population is on a carbohydrate restricted diet and looking for products not containing sugar, flour, or starch ingredients while still having the attributes of common snack foods including crunchy texture, fracturing brittleness, fracturing sound, product cohesiveness, familiar mouth feel and breakdown during chewing, customary tastes such as salt, cheese, and onion, long shelf life, and hand or mouth sized dimensions suitable for eating with one hand while driving or on the sofa without any fuss or mess. Also an optimal high protein product includes no sugars, grain, grain flours, or starch.

Further objects and advantages will become apparent from the enclosed figures and specifications.

### DRAWING FIGURES

FIG. 1a illustrates a microwavable cookware dish.

FIG. 1b illustrates an oiling the cookware step.

FIG. 1c illustrates a placing chip batter onto the cookware step.

FIG. 1d illustrates a placing cookie batter onto the cookware step.

FIG. 1e illustrates a high protein low carbohydrate chocolate chip cookie product.

FIG. 2a illustrates a pile of thick extrudible raw dough.

FIG. 2b illustrates an extruded raw dough rod.

FIG. 2c illustrates rolling of an extruded rod with an additional ingredient.

FIG. 2d illustrates a raw dough ring.

FIG. 2e illustrates a cooked high protein low carbohydrate ring product.

FIG. 2f illustrates a fractured cooked high protein low carbohydrate ring product.

FIG. 3a illustrates a pretzel shaped mold.

FIG. 3b illustrates a view of a high protein low carbohydrate pretzel product.

FIG. 3c illustrates a top view of a high protein low carbohydrate pretzel product.

FIG. 3d illustrates a side injection pretzel shaped mold.

FIG. 4 is the official Nutrition Facts product label for ExtGel based products.

### DETAILED DESCRIPTION OF THE INVENTION

This patent application is a Continuation In Part of U.S. application Ser. No. 13/573,242 filed Sep. 4, 2012 and of U.S. patent application Ser. No. 13/986,839 filed Jun. 10, 2013, both of which are incorporated in full herein by reference (but not reprinted herein to avoid redundancy).

### Crunchy Egg Chip Product Embodiment

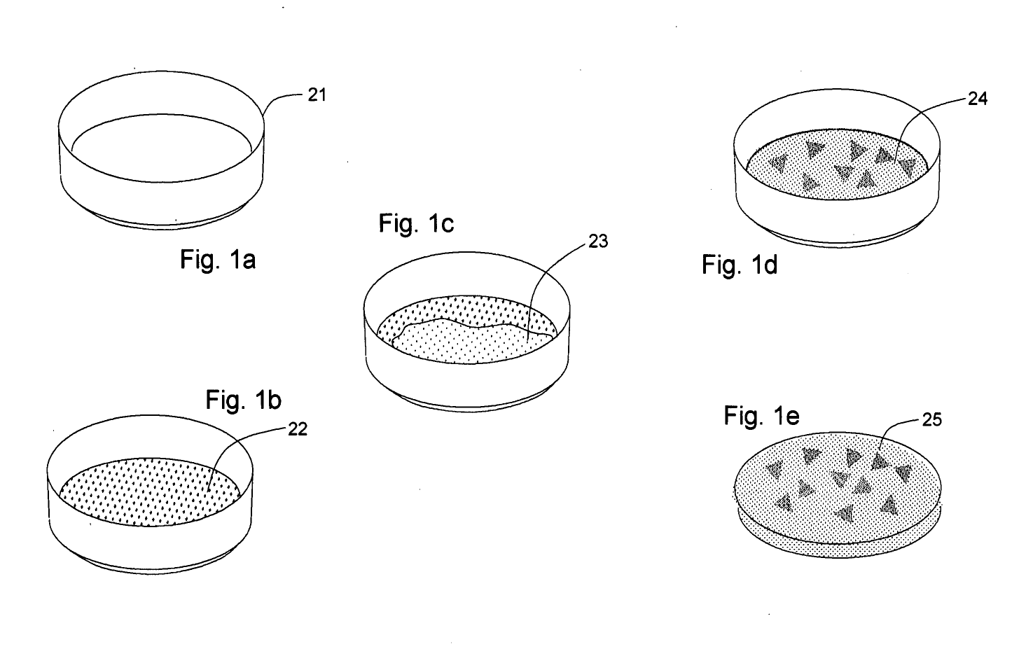

FIG. 1a illustrates a microwavable cookware dish 21 which is 3.5 inches in diameter, with a round shaped wall surrounding a flat bottom. The wall surrounding a flat bottom comprises a depression or mold into which ingredients such as a sprayed oil 21 of FIG. 1b and then a raw egg batter 22 of FIG. 1c are deposited as described herein. As discussed herein, cooking steps are achieved using a microwave oven, a conventional oven, and/or a convection oven. During the cooking processes described herein, four dishes such as that in FIG. 1a, each containing batter, are put into the microwave at a time and cooked together as a batch. For oven cooking, batter was placed upon a cookie pan and placed in the oven.

The ingredients for the following batter were mixed together, placed in the dishes, and cooked as specified. The results are described.

Following is a table describing the inputs, process, and results of a base batter. The ingredients were placed in a beaker and hand stirred for 1 minute until uniform. The base batter can be mixed with a wide range of ingredients to produce crunchy products having uniform crispiness throughout and a smooth texture similar to a potato chip.

A thinner batter (having a higher ratio of liquid egg white or water to solids) can be used to produce a thinner chip and a thicker batter (having a lower ratio of liquid egg white or water to solids) can be used to produce a thicker chip. Also more batter placed in a given mold or dish size produces a thicker chip and less batter placed in a given mold or dish size produces a thinner chip.

The base batter produces a chip that has not yet been flavored.

| | | |
|---|---|---|
| Batter Base | Liquid egg white | 1 tablespoon |
| | Egg white protein | 1 teaspoon |
| | Whey Protein | .5 teaspoon |
| | Gelatin | .5 teaspoon |
| | Safflower Oil | .5 teaspoon |
| | Peanut Oil | .5 teaspoon |
| | canola oil | .5 teaspoon |
| Dish | canola oil spray | sprayed dish |
| | add batter to dish | .5 teaspoon |
| Cook | Microwave | 1.5 minutes |
| Results | Color | golden brown |
| | Shape | random shapes almost round, |
| | | between .1 and .25 inches thick |
| | Solid | yes |
| | Crunchy | yes |
| | Mouth feel | crunchy, breaks apart nicely |
| | taste | excellent flavor |

Alternate base chips were produced that had similar crunchy, appetizing color, size, shape and other properties suitable for a appealing crunchy food product. The following table lists alternate chip ingredients. Basically a wide range of combinations of liquid egg white (water can be substituted for this), egg white protein, whey protein, and gelatin produce favorable chips each having exceptionally high ratios of protein to carbohydrates and high ratios of egg solids to other solids.

| | | | | Whey | | | | | TOTAL | | TOTAL |
|---|---|---|---|---|---|---|---|---|---|---|---|
| Solid Contents | | powdered | Jay Robb | Factors | | | | | protein unit | TOTAL | percent |
| of Base Chip | liquid | egg white | egg white | whey | | TOTAL | TOTAL | TOTAL | volume per | Egg Solids | Egg Solids |
| (Before | egg | (calculated | protein | Protein | gelatin | Units | Carb. | protein | carb unit | per Non- | per TOTAL |
| Flavoring) | white | teaspoons) | (teaspoons) | (teaspoons) | (teaspoons) | Volume | Density | density | volume | Egg Solids | Solids |
| Carbohydrate % | | 0.10 | 0.04 | 0.06 | 0.01 | | | | | | |
| by weight | | | | | | | | | | | |
| Protein % by | | 0.75 | 0.96 | 0.94 | 1.00 | | | | | | |
| weight | | | | | | | | | | | |
| Alden Base Chip | 3.00 | 0.39 | 1.00 | 0.50 | 0.50 | 2.38 | 0.06 | 0.98 | 19.50 | 1.38 | 58% |
| Unit | | | | | | | | | | | |
| Alden Base Chip | 3.00 | 0.39 | 1.00 | 0.50 | 0.00 | 1.89 | 0.06 | 0.91 | 15.80 | 2.78 | 74% |
| Unit Atl 1 | | | | | | | | | | | |
| Alden Base Chip | 3.00 | 0.39 | 1.00 | 0.00 | 0.50 | 1.89 | 0.04 | 0.98 | 20.86 | 2.78 | 74% |
| Unit Atl 2 | | | | | | | | | | | |
| Alden Base Chip | 0.00 | 0.00 | 1.00 | 0.50 | 0.50 | 2.00 | 0.04 | 0.97 | 25.75 | 1 | 50% |
| Unit Atl 3 | | | | | | | | | | | |
| Alden Base Chip | 8.00 | 1.04 | 0.00 | 0.50 | 0.50 | 2.04 | 0.07 | 0.86 | 12.58 | 1.04 | 51% |
| Unit Atl 4 | | | | | | | | | | | |

Several baked versions of the base chip were produced with the base batter. Cereal flakes roundish in shape and dark golden brown in color were produced. Multiple dots of batter each measuring 1/16 teaspoon were placed upon a baking pan which was then placed in an oven set at 375° F. and baked for six minutes. The egg flakes came out with a beautiful dark golden brown color. They were solid crunchy flakes resembling common corn flake cereal. Dozens of the egg flakes were placed in a bowl and milk was added. The flakes were sampled (eaten) periodically Over the course of ten minutes and were observed to initially be crunchy and very similar in mouth feel to common cereal flakes made from grain (such as corn flakes). As time progressed, the crunchiness diminished. Overall the appearance and eating experience was very similar to common grain based cereal flakes that have been manufactured for approximately 100 years. The difference being that the common grain based versions are very high in carbohydrates while the present version is exceptionally low in carbohydrates and incredibly high in protein (they had 19.5 units of protean for each unit of carbohydrate).

In addition to the base chip, alternate base recipes were successfully utilized to produce microwave baked and oven baked crunchy chips. Each of the Base Chip, Alt 1, Alt 2, Alt 3 and Alt 4 batters were prepared (ingredients were placed in a beaker and hand stirred for 1 minute until uniform) then ½ teaspoon placed in each of four dishes and microwaved for 1.5 minutes or several ½ teaspoon dots were placed on an oiled baking sheet and baked at 325° F. for 6 to 7 minutes to produce crunchy chips. Where chips were not fully crunchy from baking, after baking they were placed in a convention dryer at 300° F. for several minutes to drive out remaining moisture and then allowed to cool the result was a crispy crunchy chip product. Each of the Base Chip, Alt 1, Alt 2, Alt 3 and Alt 4 are gluten free. The Alt 2 chip is lactose free. The Alt 4 contains no gelatin. According to the following table, using batter SCF5a delicious cheese flavored crunchy chips were produced. Ingredients were placed in a beaker and hand stirred for 1 minute until uniform then ½ teaspoon of batter was placed in each of four dishes and microwaved for 1.5 minutes or several ½ teaspoon dots were placed on an oiled baking sheet and baked at 325° F. for 6 to 7 minutes to produce crunchy chips. Chips were also baked for shorter durations and removed while they were not fully crunchy and then placed in a low moisture air where they dried to become crispy.

Extruded raw batter embodiment—The base batter recipe was altered to include significantly less liquid. Only 0.5 teaspoon of liquid egg white and 0.5 teaspoon of safflower oil were added to the base dry ingredients. The resulting battering was a solid mass similar to bread dough. It was hand folded and hand rolled into rods with diameters between 0.25 inches and 1 inch. The rods were cooked for 45 seconds in a microwave to a semi dry state then crisped in a convention oven for 6 minutes at 375° F. The resulting product was golden brown pretzel like, very crunchy and with a mouth feel similar to a pretzel. It broke down nicely when chewed.

| | | |
|---|---|---|
| Batter SCF5a | Liquid egg white | 1 tablespoon |
| | Egg white protein | 1 teaspoon |
| | Whey Protein | .5 teaspoon |
| | Gelatin | .5 teaspoon |
| | Yellow Sprinkle Cheese | .5 teaspoon |
| | Parm and Romano | .25 teaspoon |
| | Bacon Salt | 1 smidgeon |
| | Safflower Oil | .5 teaspoon |
| | Peanut Oil | .5 teaspoon |
| | canola oil | .5 teaspoon |
| Dish | canola oil spray | sprayed dish |
| | add batter to dish | .5 teaspoon |
| Cook | Microwave | 1.5 minutes |
| Results | Color | golden brown |
| | Shape | random shapes almost round, |
| | | between .1 and .25 inches |
| | | thick |
| | Solid | yes |
| | Crunchy | yes |
| | Mouth feel | crunchy, breaks apart nicely |
| | taste | excellent deep cheese flavor |

SCF5a was also produced without the peanut oil for a crunchy flavorful chip without the peanut allergen. The amount of oil utilized in SCF5a is approximately the maximum oil the chip will hold. If more oil is added, it will drop out during cooling. As described later, batters using far less oil produced chip products and extrusion products that were crunchy, tasty and visually appealing. Substitute oils were also successfully used in all recipes herein such as canola oil, sunflower oil, safflower oil, olive oil, grape seed oil, and peanut oil (other oils can also be substituted).

Chips were produced from each recipe herein wherein and equal amount of water was substituted for liquid egg white.

High protein, low carbohydrate chocolate chip cookies were produced using batter CCF8 in the following table. CCF8 Batter was prepared (ingredients were placed in a beaker and hand stirred for 1 minute until uniform) then 2 teaspoons of batter was placed in each of four dishes and microwaved for 2.5 minutes. As in FIG. 1d, a chocolate chip cookie batter 24 was placed into and oiled dish. After cooking, as in FIG. 1d, a chocolate chip cookie 25 was produced. To demonstrate the baked product, four 2 teaspoon dots were placed on an oiled baking sheet and baked at 325° F. for 10 to 17 minutes to produce crunchy chocolate chip cookies. Cookies were also baked for shorter durations and removed while they were not yet fully crunchy and then placed in a low moisture air where they dried to become crunchy.

| | | |
|---|---|---|
| Batter CCF8 | Liquid egg white | 2 tablespoons |
| | Egg white protein | 2 teaspoons |
| | Whey Protein | 1 teaspoon |
| | Gelatin | 1 teaspoon |
| | Splenda | 1 teaspoon |
| | Sugar Free Chocolate Chips | .25 teaspoon |
| | Baker's chocolate shavings | .5 teaspoon |
| | Coconut Oil | 1 teaspoon |
| | Peanut Oil | .5 teaspoon |
| Dish | canola oil spray | sprayed dish |
| | add batter to dish | 2 teaspoons |
| Cook | Microwave | 2.5 minutes |
| Results | Color | brown |
| | Shape | round, between .25 and |
| | | .5 inches thick |
| | Solid | yes |
| | Crunchy | yes |
| | Mouth feel | crunchy, breaks apart nicely |
| | taste | excellent chocolate chip |
| | | cookie flavor |

Another batch of CCF8 was placed upon a cold oiled pan and baked in an oven at 325° F. for 17 minutes. It was cooked, crunchy and golden brown throughout.

In a chocolate chip muffin embodiment, another batch of CCF8 was placed in dishes (2 teaspoons each in four dishes) then baked in an oven at 375° F. for 6 minutes. It was cooked to be a solid mass, the muffins had crispy golden brown edges on the outside while moist but cooked and firm on the inside. Eaten while still warm, the muffins tasted and had the mouth feel of a delicious thin chocolate chip muffin. Of course it was exceptionally high in protein and low in carbohydrates.

Batter for extrusion embodiment—The ingredients of Batter ExtGGC were placed in a beaker and stirred by hand for a few minutes. The batter is very thick and non runny. The guar gum ingredient absorbs water very aggressively to thicken the batter. If placed in a microwave dish or on a baking pan as a lump, it retains that relative shape throughout cooking and forms crunchy food lump. The batter resembles a common wheat bread dough or wheat pretzel dough. Working with this thick batter enables production of thick food products with desired shapes and textures familiar to consumers such as cookies, pretzels, and crackers while replacing carbohydrate based ingredients with protein based ingredients. As in the below table, chips were produced with this dough by placing ½ teaspoon in a microwave dish and on a baking pan and then spreading it out to be flat with a desired thickness with a spoon or fork. The results is a light airy chip, as the guar gum is heated, it releases its water and shrinks leaving openings in the cooked product making it less dense than when using gelatin as a thickener. A Walnut Hollow brand manual crank extruder was filled with this batter and extruded as thin pretzel (¼ inch diameter) six inch lengths onto a baking pan and then baked. It produce tasty crunchy products.

| | | |
|---|---|---|
| Batter ExtGGC | Liquid egg white | .5 teaspoon |
| | Egg white protein | 1.5 teaspoon |
| | Whey Protein | 1 teaspoon |
| | Guar Gum | .125 teaspoon |
| | Safflower Oil | .5 teaspoon |
| Dish | canola oil spray | sprayed dish |
| | add batter to dish | place .5 teaspoon in dish |
| | | and spread out |
| Cook | Microwave | .75 minutes cooking a single |
| | | dish |
| Results | Color | golden brown |
| | Shape | random shapes almost round, |
| | | between .1 and .25 inches thick |
| | Solid | yes |
| | Crunchy | yes |
| | Mouth feel | crunchy, less dense, breaks |
| | | apart nicely |
| | taste | excellent |

Another batch of ExtGGC was mixed until consistent then placed upon a flat surface and hand rolled to be a ½ inch diameter doughy rod. The ends of the rod were connected together to make a dough circle which was then microwaved for 0.75 minutes. During microwaving, the product expanded roughly 30% and was a rigid but still contained a moisture content that prevented fracturing when bitten. It was then placed in a convection oven at 375° F. for 5 minutes. After allowing to cool, the results were a very nicely golden brown airy crunchy food product with a very nice flavor. When rolling, powders such as whey protein, egg white protein, and/or cheese powder were placed upon the rolling surface to prevent the batter/dough from sticking to the surface. These powders were substituted for flour which in conventional cooking is sprinkled upon a surface before placing wheat dough thereon for working by hand.

Batches of ExtGel were prepared exactly as ExtGGC above and produced very similar results.

| | | |
|---|---|---|
| Batter ExtGel | Liquid egg white | .5 tablespoon |
| | Egg white protein | 1 teaspoon |
| | Whey Protein | .5 teaspoon |
| | Gelatin | .5 teaspoon |
| | Salt | 1 smidgeon |
| | Safflower Oil | .5 teaspoon |
| Dish | canola oil spray | sprayed dish |
| | working batter | mix batter, roll batter, |
| | | form batter into circle |
| Cook | Microwave | .75 minutes |
| | convection oven bake | 3 minutes |
| Results | Color | golden brown |
| | Shape | circular pretzel between |
| | | .1 and .25 inches thick |
| | Solid | yes |
| | Crunchy | yes |
| | Mouth feel | crunchy, less dense, breaks |
| | | apart nicely |
| | taste | excellent flavor |

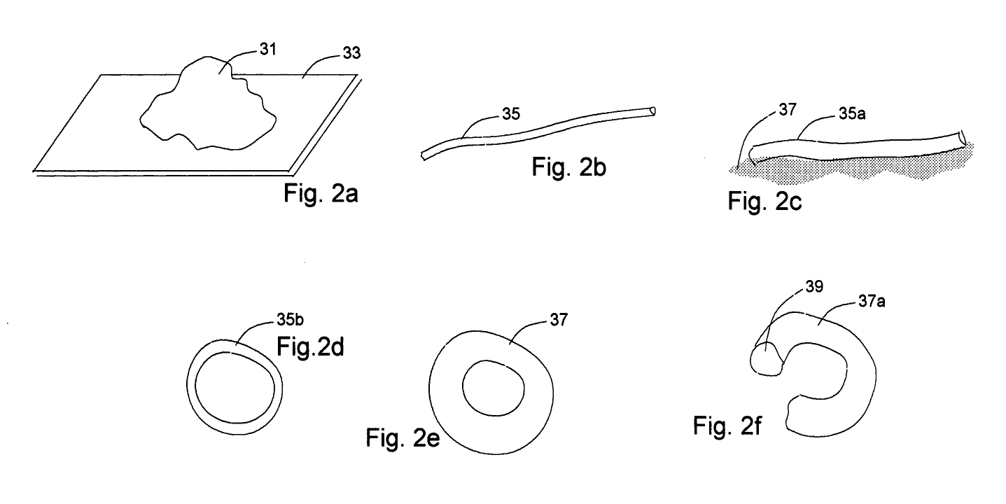

FIG. 2a illustrates a pile of thick extrudible ExtGel raw dough 31 placed upon a flat surface 33. Similar to flour based dough, the ExtGel batter stands by itself as a solid mass. The dough was placed in a Walnut Hollow extruder and extruded into an extruded raw dough rod 35. As in FIG. 2c some of the extruded rods were hand rolled with an additional ingredient 37 such as egg white protein, whey protein, salt, and/or cheese powder to become an extruded rod 35a with additional ingredients on their outer surfaces.

As in FIG. 2d in some products the ends of extruded rods were connected together to form a raw dough ring 35b.

AS in FIG. 2e the raw dough puffs when cooked in a microwave such as a cooked high protein low carbohydrate ring product 37. These are flavorful, crunchy, high in protein and low in carbohydrates.

FIG. 2f illustrates a cooked high protein low carbohydrate ring product 37a after a bite was taken out of it; the bite produces a facture surface 39 due to the crunchy brittleness of the product throughout.

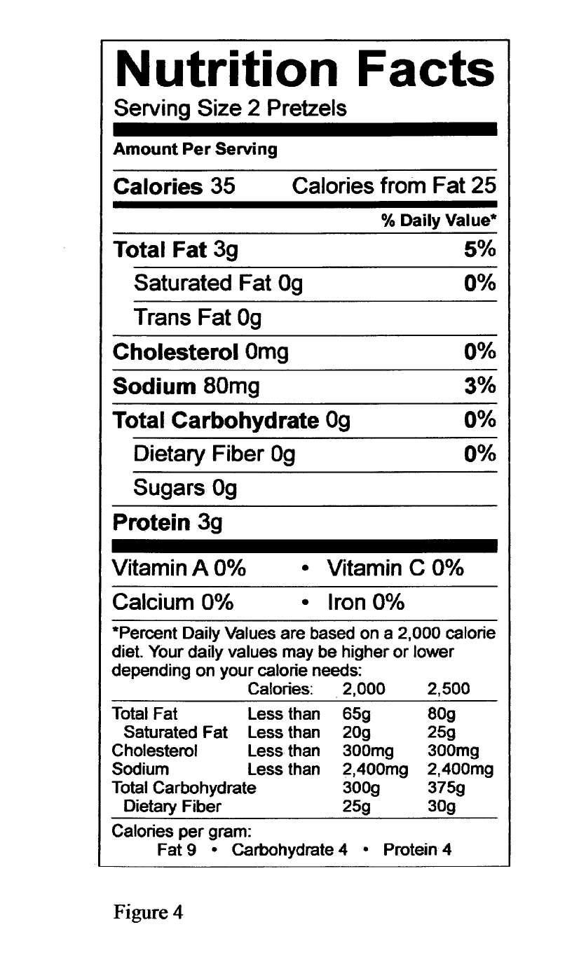

Lab analysis of ExtGel based products produced the FIG. 4 official Nutrition Facts product label. Note 3 grams of protein and 0 grams of carbohydrates. This with a product having the size, form factor, flavor, and crunchy appeal of common snack food products typically having far more carbohydrates than proteins.

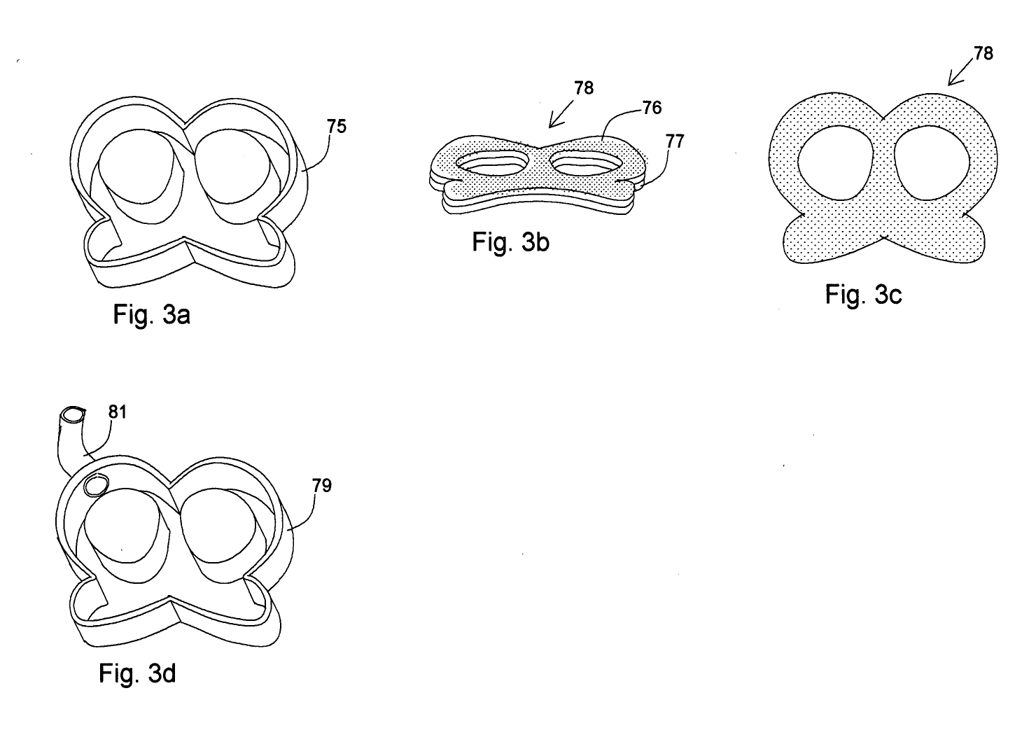

FIG. 3a illustrates a pretzel shaped mold 75 into which batter can be poured and cooked to produce a crunchy egg based pretzel based product. Different layers of batter can be used to achieve desired flavors and textures for example SCF5a can be first poured into the mold and then CCF8 batter poured on top of that. FIG. 3b illustrates a view of a high protein low carbohydrate pretzel product 78 that in one embodiment has a first layer of ingredients 76 such as SCF5a and a second layer of ingredients 77 such as CCF8. FIG. 3c illustrates a top view of the a high protein low carbohydrate pretzel product 78. FIG. 3d illustrates a pretzel shaped mold 79 with a side injection port 81. In operation the mold opening faces down and is flush against a baking pan. Batter is injected into the side injection port and then the mold is lifted leaving a pretzel shaped batter on the baking pan which is then cooked. ExtGGC and the ExtGel batters are suitable to be injected into the mold and will retain their shape once the mold is lifted.

An alternate extrudible dough was produced using no hydrocolloid using the following ExtSans batter. It produced a crunchy product.

| | | |
|---|---|---|
| Batter ExtSans | Liquid egg white | .5 tablespoon |
| | Egg white protein | 1 teaspoon |
| | Whey Protein | 1 teaspoon |
| | Safflower Oil | .5 teaspoon |
| Dish | canola oil spray | sprayed dish |
| | working batter | mix batter |
| Cook | Microwave | 40 seconds |
| | convection oven bake | 3 minutes |
| Results | Color | golden brown |
| | Shape | varied |
| | Solid | yes |
| | Crunchy | yes |
| | Mouth feel | crunchy, breaks apart nicely |
| | taste | excellent flavor |

Extrudible egg based batter is mentioned in United States Patent Application 2013/0022731, Olson wherein the ingredients are cooked in the extruder. Extrudible egg based batters are mentioned in U.S. Pat. No. 7,939,123 Tillis, and U.S. Pat. No. 7,943,191 Tillis wherein the ingredients are thickened by first being coagulated (cooked) and then being extruded and cooked more. By contrast with the prior art references to extrusion, the present invention utilizes a highly restricted moisture content batter which is first mixed, then extruded, once extruded will generally retain its shape similar to a solid, is placed upon a cooking surface, and is then cooked to a crunchy state. Prior to being extruded, nearly all of the liquid water and liquid oil are absorbed by addition of a high percentage of dry ingredients such as dry egg white protein, dry whey protein, and/or dry hydrocolloid. Thus the batter is still workable and flow able for extrusion and injection like a liquid but will retain its shape like a solid.

As discussed herein and in related applications referred to herein, crunchy food products were produced which comprised specific combinations of ingredients that ranged in the following percentages and the resulting products were exceptionally high in protein and low in carbohydrates. The table describes final ingredient contents by volume.

| | Minimum Content | Maximum Content |
|---|---|---|
| INGREDIENT | By Volume | By Volume |
| Egg | 20% | 95% |
| Egg Protein | 20% | 95% |
| Protein | 20% | 95% |
| Carbohydrates | 0% | 40% |
| Oil | 1% | 60% |
| Fat | 1% | 60% |
| Water | 0% | 15% |
| Milk Derivatives | 0% | 50% |
| Whey Protein | 0% | 50% |
| Hydrocolloid | 0% | 35% |

### Operation of the Invention

Operation of the invention has been discussed under the above under the Detailed Description of the Invention heading and is not repeated here to avoid redundancy.

### CONCLUSION, RAMIFICATIONS, AND SCOPE

Thus the reader will see that the crunchy egg product, manufacturing apparatus, and manufacturing processes of this invention provides a well defined and desirable consumer product that is nutritious and fulfills a gap in crunchy low carbohydrate snack food product category. While the above description describes many specifications, these should not be construed as limitations on the scope of the invention, but rather as an exemplification of a preferred embodiment thereof. Many other variations are possible.

The egg ingredient herein can comprise whole egg or any egg product derived there from including glucose reduced dried egg, glucose reduced dried egg white, or egg white protein for example.

It should be noted that the phrase “raw egg batter” is used herein to distinguish between the batter, solidified egg, and crisped egg. In fact the egg portion of the batter may consist of only dried egg or dried egg white in which case no literal raw egg is utilized.

Raw egg deposition or batter deposition means placing the batter into a position for cooking for example; depositing batter onto a surface, extruding batter onto a surface, depositing batter into a flyer, extruding batter into a fryer, and extruding batter into air that is then heated or microwaved.

The term solidifying is used herein to mean transitioning of the batter from a liquid or foam state to a high moisture content solid state, solidifying is a cooking process.

The term crisping is used here to mean transitioning of the solidified egg into a low moisture crunchy product. Crisping is a cooking process and/or a drying process.

Ingredients are mixed together herein, whipping is a specialized form of mixing that may for example mean mixing air or other gases into the raw egg or the batter to achieve certain properties suitable for the crunchy puffed egg product for example.

Spraying onto the solidified egg is described as a color, flavoring, texture, or oil additive step. Other additive steps are possible such as sprinkling onto the solidified egg, and tumbling the solidified egg in a bath of dried or moist flavorings. Similarly the batter can receive additives through spraying, sprinkling, and tumbling and the crisped egg can receive additives through spraying, sprinkling, and tumbling.

Microwaving was specified as a cooking process to transition egg from a raw batter state to a solidified state. It should be noted that other cooking methods such as baking and frying can be substituted. Microwaving was specified as a cooking process to transition egg from a solidified state to a crispy state. It should be noted that other cooking methods such as baking and frying can be substituted. Microwaving was specified as a cooking process to transition egg from a solidified state to a tough and chewy state. It should be noted that other cooking methods such as baking and frying can be substituted. Microwaving was specified as a drying method to remove moisture from an egg based batter. It should be noted that drying method such as dry air and baking can be substituted.

References are made herein to cooking processes, and drying processes. It is understood that the ingredients and processes herein can be adapted to work with alternate cooking apparatuses such as tunnel microwave oven (using electromagnetic energy), tunnel RF oven (using electromagnetic energy), tunnel oven (using thermal energy), tunnel convection oven (using thermal energy), tunnel dryer, commercial fryer (using thermal energy), etc.

Water and liquid egg white can be substituted for one another in recipes to achieve similar results.

Whey protein, dry buttermilk, dry milk, milk, cheese flavoring, and other combinations of whole milk or derivatives of milk all comprise a dairy ingredient.

Gelatin, and Guar Gum are hydrocolloids often used as thickening agents in food recipes. Alternate hydrocolloids and/or thicken agents may be substituted.

The terms “batter” and dough can be used interchangeably to mean uncooked ingredients.

1-26. (canceled)

27) A crunchy egg based food manufacturing process comprising the steps of providing ingredients comprising a ratio of parts protein to parts carbohydrate that is 1 to 1 or greater, wherein a cooking step is performed such that after cooking and prior to consumption said product comprises 15% or less moisture and solids comprise 20% or greater egg solids not counting fats or oils, wherein in testing said product it fractures in a three point bend test, and wherein upon fracturing a cracking sound is produced.

28) The crunchy egg based food manufacturing process of claim 27 wherein provided ingredients include at least one high protein ingredient selected from the group consisting of a milk based ingredient, an egg based ingredient, and a gelatin based ingredient.

29) The crunchy egg based food manufacturing process of claim 27 wherein, during manufacturing microwave energy is used in a step selected from the group consisting of; said product is heated by microwave energy, microwave energy causes the egg ingredient to transition from a non-solidified state to a solidified state, microwave energy causes the product to transition from a solidified moist state to a crunchy state, microwave energy cooks the product, and microwave energy causes moisture in the product to be reduced.

30) The crunchy egg based food manufacturing process of claim 27 wherein, during manufacturing an ingredient mixing step is performed selected from the group consisting of; mixing a liquid batter, mixing a solid batter, and whipping batter to cause it to be aerated.

31) The crunchy egg based food manufacturing process of claim 27 wherein provided ingredients include at least one attribute selected from the group consisting of; a low carbohydrate sugar substitute is provided, added starch ingredients comprise less than 25% of ingredients, no starch ingredient is added, no added ingredient comprising 25% or more of the products solids comprise carbohydrates of 30% or more, added flour ingredients comprise less than 25% of ingredients, and no flour ingredient is added.

32) The crunchy egg based food manufacturing process of claim 27 wherein provided ingredients comprise a ratio of parts protein to parts carbohydrate that is 1.25 to 1 or greater.

33) The crunchy egg based food manufacturing process of claim 27 wherein provided ingredients comprise a ratio of parts protein to parts carbohydrate that is 1.5 to 1 or greater.

34) The crunchy egg based food manufacturing process of claim 27 wherein provided ingredients comprise a ratio of parts protein to parts carbohydrate that is 1.75 to 1 or greater.

35) The crunchy egg based food manufacturing process of claim 27, wherein during manufacturing one or more steps are performed selected from the group consisting of; batter is first deposited onto a surface and then cut into a desired product shape, batter is first deposited onto a surface then solidified and then cut into a desired product shape, batter is deposited onto a surface as individual product pieces, batter is deposited into a mold to form a desired product shape, the product is heated in a microwave, the product is heated in an oven, and the product is heated in an oil.

36) The crunchy egg based food manufacturing process of claim 27, further characterized by one selected from the group consisting of; a single product piece is sized for easy manipulation with one hand, multiple product pieces fit on a tablespoon for consumption as a breakfast cereal, the product form resembles a pretzel, the product form resembles a pretzel rod, the product form resembles a potato chip, the product form resembles a tortilla chip, the product form resembles a cookie, the product form resembles a cracker, the product form resembles a puffed extrusion, the product form resembles a cheese puff, the product form resembles a cheese curl, the product form resembles a ring shape, a product piece is translucent, wherein printed text placed behind the product can be read through the product, wherein the crunchy product is adhered to a second crunchy product having different product characteristics, and wherein the crunchy product is adhered to a second food that is not crunchy.

37) A crunchy egg based food product comprising
a ratio of parts protein to parts non-protein that is 1 to 1 or greater by volume, egg solids comprise 50% or greater of solids by volume not including oils or fats, wherein said product fractures in a three point bend test, wherein upon fracturing a cracking sound is produced, and said product comprises 15% or less moisture.

38) The crunchy egg based food product of claim 37 wherein, a ratio of parts protein to parts carbohydrates that is 2.44 or greater by volume.

39) The crunchy egg based food product of claim 37 wherein, high protein ingredients include one selected from the group consisting of a milk based ingredient, an egg based ingredient, and a gelatin based ingredient.

40) The crunchy egg based food product of claim 37 wherein, during manufacturing microwave energy is used for one selected from the group consisting of; said product is heated by microwave energy, microwave energy causes the egg ingredient to transition from a non-solidified state to a solidified state, microwave energy causes the product to transition from a solidified moist state to a crunchy state, and microwave energy causes moisture in the product to be reduced.

41) The crunchy egg based food product of claim 37 wherein, during manufacturing said ingredients are mixed as one selected from the group consisting of; a liquid batter, a solid batter, and a whipped batter.

42) The crunchy egg based food product of claim 37 wherein, ingredients are further characterized to include one selected from the group consisting of; a low carbohydrate sugar substitute is added, added starch ingredients comprise less than 10% of ingredients, no starch ingredient is added, no added ingredient comprising 25% or more of the products solids comprise carbohydrates of 30% or more, added flour ingredients comprise less than 10% of ingredients, and no flour ingredient is added.

43) The crunchy egg based food product of claim 37 wherein, said product comprises a ratio by volume of parts protein to parts non-protein that is 2 to 1.5 or greater.

44) The crunchy egg based food product of claim 37 wherein, said product comprises a ratio by volume of parts protein to parts non-protein that is 4 to 1 or greater.

45) The crunchy egg based food product of claim 37 wherein, during manufacturing one or more steps are performed selected from the group consisting of; batter is first deposited onto a surface and then cut into a desired product shape, batter is first deposited onto a surface then solidified and then cut into a desired product shape, batter is deposited onto a surface as individual product pieces, batter is deposited into a mold to form a desired product shape, the product is heated in a microwave, the product is heated in an oven, and the product is heated in an oil.

46) The crunchy egg based food product of claim 37 wherein, further characterized by one selected from the group consisting of; a single product piece is sized for easy manipulation with one hand, multiple product pieces fit on a tablespoon for consumption as a breakfast cereal, the product form resembles a pretzel, the product form resembles a pretzel rod, the product form resembles a potato chip, the product form resembles a tortilla chip, the product form resembles a cookie, the product form resembles a cracker, the product form resembles a puffed extrusion, the product form resembles a cheese puff, the product form resembles a cheese curl, the product form resembles a ring shape, a product piece is translucent, wherein printed text placed behind the product can be read through the product, wherein the crunchy product is adhered to a second crunchy product having different product characteristics, and wherein the crunchy product is adhered to a second food that is not crunchy.

47) A crunchy egg based food product comprising
a ratio of parts protein to parts non-protein that is 1 to 1 or greater by volume,
egg ingredients comprise 25% or greater by volume,
wherein said product fractures in a three point bend test, wherein upon fracturing a cracking sound is produced, and said product comprises 15% or less moisture.

48) The crunchy egg based food product of claim 47 wherein, a ratio of parts protein to parts carbohydrates that is 2.44 or greater by volume.

49) The crunchy egg based food product of claim 47 wherein, high protein ingredients include one selected from the group consisting of a milk based ingredient, an egg based ingredient, and a gelatin based ingredient.

50) The crunchy egg based food product of claim 47 wherein, during manufacturing microwave energy is used for one selected from the group consisting of; said product is heated by microwave energy, microwave energy causes the egg ingredient to transition from a non-solidified state to a solidified state, microwave energy causes the product to transition from a solidified moist state to a crunchy state, and microwave energy causes moisture in the product to be reduced.

51) The crunchy egg based food product of claim 47 wherein, during manufacturing said ingredients are mixed as one selected from the group consisting of; a liquid batter, a solid batter, and a whipped batter.

52) The crunchy egg based food product of claim 47 wherein, ingredients are further characterized to include one selected from the group consisting of; a low carbohydrate sugar substitute is added, added starch ingredients comprise less than 10% of ingredients, no starch ingredient is added, no added ingredient comprising 25% or more of the products solids comprise carbohydrates of 30% or more, added flour ingredients comprise less than 10% of ingredients, and no flour ingredient is added.

53) The crunchy egg based food product of claim 47 wherein, said product comprises a ratio by volume of parts protein to parts non-protein that is 2 to 1.5 or greater.

54) The crunchy egg based food product of claim 47 wherein, said product comprises a ratio by volume of parts protein to parts non-protein that is 4 to 1 or greater.

55) The crunchy egg based food product of claim 47 wherein, during manufacturing one or more steps are performed selected from the group consisting of; batter is first deposited onto a surface and then cut into a desired product shape, batter is first deposited onto a surface then solidified and then cut into a desired product shape, batter is deposited onto a surface as individual product pieces, batter is deposited into a mold to form a desired product shape, the product is heated in a microwave, the product is heated in an oven, and the product is heated in an oil.

56) The crunchy egg based food product of claim 47 wherein, further characterized by one selected from the group consisting of; a single product piece is sized for easy manipulation with one hand, multiple product pieces fit on a tablespoon for consumption as a breakfast cereal, the product form resembles a pretzel, the product form resembles a pretzel rod, the product form resembles a potato chip, the product form resembles a tortilla chip, the product form resembles a cookie, the product form resembles a cracker, the product form resembles a puffed extrusion, the product form resembles a cheese puff, the product form resembles a cheese curl, the product form resembles a ring shape, a product piece is translucent, wherein printed text placed behind the product can be read through the product, wherein the crunchy product is adhered to a second crunchy product having different product characteristics, and wherein the crunchy product is adhered to a second food that is not crunchy.
